(19) United States
(12) Patent Application Publication
(10) Pub. No.: US 2003/0208472 A1
(43) Pub. Date: Nov. 6, 2003

(54) Method and apparatus for transparent keyword-based hyperlink

(76) Inventor: Peter Manh Pham, San Jose, CA (US)

Correspondence Address: Peter Manh Pham, 275 E. Taylor Street, San Jose, CA, 95112, US

(21) Appl. No.: 10/427,082

(22) Filed: Jan. 23, 2003

Related U.S. Application Data
(63) Continuation-in-part of application No. 09/547,117, filed on Apr. 11, 2000, now abandoned.

(51) Int. Cl. G06F 15/16; G06F 17/00; G06F 7/00

(52) U.S. Cl. 707/2; 709/203; 707/104.1

(57) ABSTRACT

A method and apparatus for transparently linking keywords displayed in a document viewer on a display monitor attached to the said computer system to information on a remote web-based information retrieval system (or web site) comprises of an access agent executing on a computer system. The said web site is coupled to the said computer system over a computer network and executes a keyword lookup server as a server-side program (CGI) for providing a keyword-based information retrieval service which is remotely accessible using standard Universal Resource Locator (URL) web access method (or HTTP). The said access agent installs one or more input device handlers for intercepting and scanning user input for one or more pre-configured hot key. Each of the said hot keys is mapped to one or more URLs which contain a special marker to be replaced by a keyword selected by the user and is used to access the said lookup service for retrieving information associated with the said user-selected keyword. The user selects the said keyword displayed in a document viewer by highlighting it or positioning an input device's cursor on or at it and then applies a said hot key. The said hot key consequently triggers the said access agent to retrieve the said URL associated with the said hot key and the said user-selected keyword from the display buffer associated with the said document viewer window. Next, the said access agent replaces the special marker in the said URL with the said user-selected keyword and then invoke a web browser using the said URL for retrieving information associated with the said keyword and handling the retrieved information.

### OTHER PUBLICATIONS

Hypertext Transfer Protocol—HTTP version 1.1, R. Fieldings, J. Gettys, J. Mogul, H. Frystyks, T. Berner-Lee, June1999, IETF RFC-2616.

Unified Resource Identifiers, R. Fieldings, T. Berner-Lee, L. Masinter, August 1998, IETF-2396

HTML 4.0 Specification, HTML Home Page, hftp://www.w3.org/MarkUp

Pat. No. 5,392,386, February 1994, Chalas et al., 345/841

Pat. No. 6,442,540, September 1998, Sako et al., 703/3

### TECHNICAL FIELD

The present invention relates to the fields of computer network, in general, and web object access, in particular. More specifically, the present invention relates to a method for transparently linking keywords displayed in a document viewer to information and web objects over a computer network. Hot key is a general term referring to a defined input pattern generated by a corresponding input device that can be a keyboard, mouse, pen, voice recognition device, etc. For example, for a standard PC keyboard, the hot key typically is a function key, a keyboard combination of one or more special key (Ctrl, Alt and Shift) and any other keys, etc. For a mouse input device, the hot key could be a left or right mouse click, a left mouse double-click, etc. The hot key is specified in standard encoded format used by the input device's driver, e.g. for keyboard, the input encoding consists of an input character code and special key flags. A “web object” is a network resource identified by a so-called “web object identifier” that is specified in absolute URI (Uniform Resource Identifier) syntax (see IETF RFC-2068). Thus, a web object specifies a network resource retrievable or accessible using one of a variety of transport protocols as allowed by the RFC-2068 and related specification, not just HTTP, for example, file transfer protocol (FTP). Examples of web objects are web page, file, video or audio script, printer, submit form, search engine, server-side process, etc. Examples of web objects are static or dynamic web page, server-side program (CGI), file, etc. A keyword is a string of printable characters including white spaces and tabs. In this sense, a keyword is not limited to a single word but might also be a multi-word phrase or a block of white space-separated words. Hypertext is a text distinctly displayed as user-selectable item in a document viewer, such as a web browser, and associated with a hyperlink linking the said hypertext to a web object. Hyper-image is similar to hypertext but applied to images displayed in a document viewer.

### BACKGROUND ART

Presently, taking advantage of the Internet for instant access and global present, many information retrieval applications have found their way to the Internet in the form of web-based applications. While Internet certainly is an efficient information delivery platform, web-based applications suffer the disadvantage of limited access to local system resources such as input devices and, therefore, lacks the quick access ability of a traditional stand-alone applications for personal computer. For example, to lookup for a word on a web-based dictionary web site, the user typically has to access the web site hosting the desired dictionary, type in a desired word in a query form and then click on a Submit button to submit the query form for processing. Similarly, a web-based search engine also requires the same three-step access-input-submit process. This three-step access-input-submit process is quite cumbersome and time-consuming in comparison to the same application on a personal computer.

In contrast, stand-alone application software for personal computer has the advantage of direct access to various system resources, especially input devices, to enhance their user interface with various shortcut methods. For example, a stand-alone dictionary lookup application allows the user to lookup for a word by simply highlighting a selected word and then applying a hot key to trigger a lookup operation on the selected word. Some applications even go further by allowing the user to do the same by just double-clicking on the selected word. As a result, access to application software for personal computer is often more efficient through the use of shortcut methods. A well-known shortcut method is by mapping a pre-defined input pattern known as “hot key” from an input device to one or more synchronous operations to eliminate repetitive time-consuming user interaction. Instead of going through several interaction steps to gain access to a piece of data in a database-oriented application, a user-friendly software allows the user to do the same in just a key stroke or mouse click as given in the dictionary lookup example above. On the other hand, stand-alone application software lacks the advantages of instant updates and global access that web-based applications enjoy and are the driving force behind the success of the Internet.

Today, using Microsoft Internet Explorer web browser, one can search for information associated with a keyword by typing the keyword to the “Address” field of the Internet Explorer. The web browser automatically redirects the user to either a search engine submitting the typed-in keyword as the search key. However, this process still a manual process requiring the user to first invoke the web browser and then type in the keyword in the “Address” field.

In another related problem, today web browsing technology is based on hypertext for establishing linkage between one web page to another. In prior art, the linkage, a.k.a. hyperlink, is a URL specifying a target web object and included in the web page on a per-hypertext basis. Since the hyperlink is expressed in location-dependent expression such as the said URL, when the web object is moved to a different location, probably due to a need for reorganization the file system where the web object is hosted, access to the said web object is lost. This problem is well-known as the “lost-link” problem. This problem can only get worse when the said URL hyperlink are embedded in web documents as required by HTML specification and potentially bookmarked by random Internet users on the world-wide-web. Presently, the only way to correct this situation is to leave a script in the old location to redirect the requesting web browser to retrieve the moved web object at a new location. Since web contents are rather dynamic especially for large sites with highly dynamic contents such as news sites, one can imagine that the need for re-organization of web contents on such sites can occur very frequently and further exaggerates the problem. The result is that either people will lose access to information they once thought they have access to or the web content publisher must spend a great deal of effort to ensure that access to every moved web object are redirected properly. However, the disadvantages of hard-coded URL hyperlink do not end there. Embedding URL hyperlink in web pages also forces the web content publishers to update the URL hyperlink of a moved web object in all web documents referencing it. As a result, managing web documents is typically a complicated, detail-oriented and exhaustive task for many web content publishers and, of course, such disadvantages greatly effect productivity and impose high cost of publishing and maintaining web contents.

### SUMMARY OF THE INVENTION INCLUDING OBJECTS AND ADVANTAGES

Accordingly, it is an object of the present invention to provide a method and a system for transparently hyperlinking keywords displayed in a document viewer window on a display monitor attached to a computer system to network information and resources, in general, and web objects, in particular. The method for achieving this object is to transparently retrieve a user-selected keyword display in a said document viewer window, invoke a web browser and request the web browser to retrieve information associated with the said keyword on the said web-based information retrieval system (or web site for short). The said system comprises of a plurality of end-user computer systems and one or more web sites coupled to the said end-user computer systems over a computer network such as the Internet. Each of the said end-user computer systems has a processing unit, a display unit and at least an input device and executes an access agent, a web browser and at least a document viewer such as a word processor, a text editor, etc. Each of the said web sites executes a keyword lookup server for providing keyword-based information lookup service. The said lookup service is remotely accessible through a web server also executing on each said web site using standard web resource access method well-known as Universal Resource Locator (URL). Said URL for accessing the said lookup service is called “query URL” for short. The retrieved information can be a web page, a document, a multimedia script, a web object identifier, e.g. URL, or anything that can be processed by a commercial web browser. On startup, the said access agent loads a hot key table in memory. The said hot key table is pre-configured by the user and stored in a configuration file on the local system. It contains one or more hot key entries, each of which associates a hot key with one or more corresponding said query URLs. Each of the said query URLs embeds a special marker to be replaced by the user-selected keyword. The access agent then installs an input device interceptor for intercepting and scanning user's input for one of the hot keys stored in the said hot key table. In the present invention, a hot key is used to signal the user's desire to retrieve information using a query URL associated with the said hot key. The user selects a keyword displayed in a said document viewer either by highlighting it or positioning the cursor of an input device on it and then applies a hot key. Upon intercepting the said hot key from the input device, the interceptor uses the hot key to retrieve the associated query URL from the said hot key table, assuming only one query URL is mapped to the said hot key. Next, the said interceptor retrieves the said user-selected keyword in the document viewer on the display monitor using either the highlight display attribute for identifying the keyword boundary or the cursor's location for identifying the location of a word. If the said keyword is successfully retrieved, the said interceptor replaces the special marker in the said query URL with the said keyword and then invokes a web browser on the user's system, if an instance of the said web browser has not yet been running. Next, the said interceptor requests the said web browser to retrieve information associated with the user-selected keyword using the said query URL. The resulting retrieved information will be handled by the said web browser in accordance to its standard receive data handling procedures. In the event the said hot key is mapped to more than one query URLs, the interceptor retrieves all the query URLs associated with the said hot key and replaces the special marker in every of the said query URLs with the said user-selected keyword. It then generates a web page with the said query URLs presented as hypertexts, each is hyperlinked to the corresponding query URL. Next, the interceptor invokes a web browser on the user's system, if an instance of the said web browser has not yet been running, and requests the web browser to load the said generated web page in the web browser window. Once the said generated web page is displayed in the web browser window, the user can browse for desired information on the web sites associated with the said query URLs by navigating through the said hypertexts.

Another object of the present invention is a method and a system for keyword-based hyperlink of web objects in a computer network such as the Internet. The method is to associate one or more keywords with a URL hyperlink referencing a local or remote web object and store the said association in a keyword-to-URL database on a web site. Then, using the said keywords instead of the URL as the hyperlink of a hypertext in a web page hosted on the said web site. When the user selects a keyword-hyperlinked hypertext on display in a web browser window, the assigned keyword is resolved into a corresponding hyperlink stored in the said keyword-to-URL mapping database, which is then used to retrieve the target web object. The system comprises of a plurality of end-user computer systems and one or more of web sites. The end-user computer systems and the said web sites are coupled to each other over a computer network such as the Internet. Each of the said end-user computer systems has a processing unit, a display unit and at least an input device and executes a web browser enhanced with the capability of performing the said keyword-based hyperlink resolution. Each of the said web sites hosts a said keyword-to-URL mapping database and executes a keyword lookup server operating on the said keyword-to-URL mapping database for providing a keyword resolution service using standard web access method well-known as Universal Resource Locator, or URL for short. The said URL is a hyperlink identifying either a local or remote web object. The keyword hyperlink process starts with a keyword being assigned as a hyperlink of a hypertext in a web page loaded in the web browser window. A new hyperlink variable is introduced to the hypertext markup language (HTML) to allow for the assignment of a keyword as a hyperlink. As done in prior art, when the web browser loads the web page, it also scans the web page for analysis. A new procedure introduced to the web browser's analysis to allow the said web browser to recognize the said hyperlink variable together with the keyword assigned to it. Upon detecting such keyword hyperlink in a hypertext, the web browser stores the text part of the hypertext in association with the keyword hyperlink in a keyword table. When a user selects a hypertext of which hyperlink is a keyword, the web browser retrieves the text of the hypertext and uses the retrieved text to retrieve the associated keyword from the said keyword table. After the keyword is successfully retrieved, the web browser then composes a query URL for querying the web site where the web page is loaded from for the web object associated with the said keyword. The query URL is composed by taking the home URL of the said web site, e.g. http://www.uspto.com, and appending a conventional pathname of the keyword resolution server on the said web site, followed by the said keyword hyperlink in a conventional syntax understood by the said keyword lookup server. Another method for dynamically composing a query URL is to embed a query URL specifying the keyword lookup service on the said web site in the web page itself. A new private HTML tag is introduced to assist the web browser from identifying such query URL in the web page. Similar to the previous object, the query URL contains a special marker to be replaced by the keyword hyperlink in resolution. Upon detecting such an HTML tag in a loading web page, the web browser retrieves and stores the query URL for later use. After the query URL is dynamically generated using one of the above methods, the web browser then uses the said query URL to retrieve the web object associated with the said keyword hyperlink from the said web site. When the said keyword lookup server on the said web site receives the said query URL, it parses the said query URL for the keyword and uses the said keyword as a search key for finding an exact match of the said keyword in the said local keyword-to-URL mapping database. If the said lookup results no match, the said lookup server returns an “object not found” error message and responds to the said web browser with the said error message. If the said lookup results a matching mapping entry, and the said URL of the said matching mapping entry references a local web object, the said lookup server uses the said URL to retrieve the target web object and responds to the said web browser with the data of the said web object. If the said URL of the said matching mapping entry, the said lookup server generates a redirection message with the said URL as the redirect target and responds to the said web browser with the said redirection message. If the said lookup results in more than one mapping entries, the said lookup server generates a web page listing the URL of the said matching mapping entries as hypertexts and responds to the said web browser with the data of the said web page.

Another object of the present invention is a method and system for advertising selected keyword-to-URL mapping entries on the said web sites on a central keyword resolution system. The said central keyword resolution system hosts a keyword-to-URL mapping database and executes a web server, a keyword lookup server and an upload server. The central keyword-to-URL mapping database stores keyword mapping entries uploaded from the said web sites. The keyword lookup server and the web server are as described in the previous object. The upload server is used to handle upload requests from the said web sites over a TCP connection using a private or public service port, e.g. HTTP port. Each of the said web sites further executes an upload client process triggered either by a timer on a periodic basis or by a human operator on demand basis. When the upload client process on a said web site is invoked due to a timer or a human operator, it establishes an upload session with the upload server using the said transport protocol and service port. When the said session is successfully established, the said upload client can start uploading distinctly-marked keyword mapping entries from the local keyword-to-URL mapping database. As mentioned above, only selected mapping entries are advertised on the central keyword resolution systems. The said selected entries are distinctly marked when they are added to the said local keyword mapping database. After they are successfully uploaded, their distinct marker will be cleared to avoid reloading in the next upload run. Upon receiving the said uploaded mapping entries, the said upload server stores them in a temporary database known as submission mapping database to be later published to the “official” keyword-to-URL mapping database by the operator of the said central system. In the event the keyword lookup server on the said web site fails to locally resolve the keyword hyperlink, the said keyword lookup server is now responsible for redirecting the said web browser to further resolve the said keyword on the said central system.

Thus, an obvious advantage of the present invention is that it effectively optimizes the user's interaction in retrieving desired information on the world-wide-web associated with a keyword displayed in a document viewer from several tedious manual actions into simple two actions: highlighting desired keyword and applying a hot key. Such optimization is application-independent and, thus, can be applied to a wide variety of applications and, as a result, helps to greatly improve productivity for many Internet users globally, especially when it comes to searching for information from multiple information sources on the Internet. Another benefit of the present invention is in its application to keyword hyperlink. It has been demonstrated that, by storing the actual web object hyperlinks (URLs) in a keyword-to-URL mapping database on the web server instead of hard-coded in the web content pages, referenced web objects in web content becomes location-independent. This, in turn, helps to eliminate, or at least reduce, the “lost-link” problem associated with prior art. Furthermore, the present invention of keyword hyperlink and centralized management of URL hyperlinks also significantly simplify the tasks of managing web objects on a web site. As changes to web objects' location can easily be updated in a single place, the mapping database, instead of in all web contents effected by the changes as now in practice by prior art.

Still further objects and advantages will become apparent from a consideration of the ensuing description and accompanying drawings.

### BRIEF DESCRIPTION OF THE DRAWINGS

FIG. 1 demonstrates the present invention of a plurality of end-user computer systems, each executing an access agent, and one or more web-based information retrieval systems (or web site) coupled to each other over a computer network. The arrow indicates the flow of data.

FIG. 2 is a block diagram demonstrating the components of the access agent of the present invention on an end-user computer system and the access agent's interface with a remote web site.

FIG. 3 demonstrates the hot key table with one or more hot key mapping entries. Each entry maps a hot key to one or more URLs along with a brief description.

FIG. 4.a is a flowchart demonstrating the access agent's processing of a hot key mapped to a single URL.

FIG. 4.b is a flowchart demonstrating the access agent's processing of a hot key mapped to multiple URLs.

FIG. 5 is a flowchart demonstrating the network access module (web browser) process of sending information retrieval request to a remote web site, receiving and handling of response from the said remote web site.

FIG. 6 demonstrates the display of a web page generated by the access agent listing the mapped URLs as hypertext when a hot key is mapped to multiple URLs.

FIG. 7.a demonstrates the structure of the keyword-to-URL mapping entry.

FIG. 7.b is a flowchart demonstrating the enhanced web browser's processing when the user clicks on a hypertext of the present invention, which may be hyperlinked to a target web object using either a keyword or URL.

FIG. 8 is a flowchart demonstrating the enhanced web browser's process of sending hyperlink resolution request to the remote web site, receiving and handling of response from the said remote web site.

FIG. 9 is a flowchart demonstrating the present invention of a hyperlink resolution process executed by the keyword lookup server on a web site of the present invention.

FIG. 10 demonstrates the display of a web page generated by the keyword lookup server listing the matching URL hyperlinks as hypertexts when the lookup of a given keyword hyperlink results in multiple mapping entries.

FIG. 11 demonstrates the present invention of a keyword hyperlink system comprising of a plurality of end-user computer systems, one or more web-based information retrieval systems (or web site) and a central keyword resolution system coupled to each other over a computer network. The arrow indicates the flow of data. The dash arrow indicates the

FIG. 12.a demonstrates a web site of the present invention with a keyword lookup server for providing keyword resolution service and keyword export module for uploading selected keyword-to-URL mapping entries to the central keyword resolution system.

FIG. 12.b demonstrates the structure of the keyword-to-URL mapping entry with the addition of the Export flag used to qualify for uploading to the central keyword resolution database.

FIG. 13 is a block diagram demonstrating the components of the web site of the present invention and the components of the central keyword resolution system of the present invention.

FIG. 14 is a flowchart demonstrating the keyword resolution process of the keyword lookup server on the web site of the present invention. This process is modified from the flowchart in FIG. 9 to include the logic for redirecting the requesting web browser to the central keyword resolution system for further keyword resolution if the lookup on the said web site results in no match.

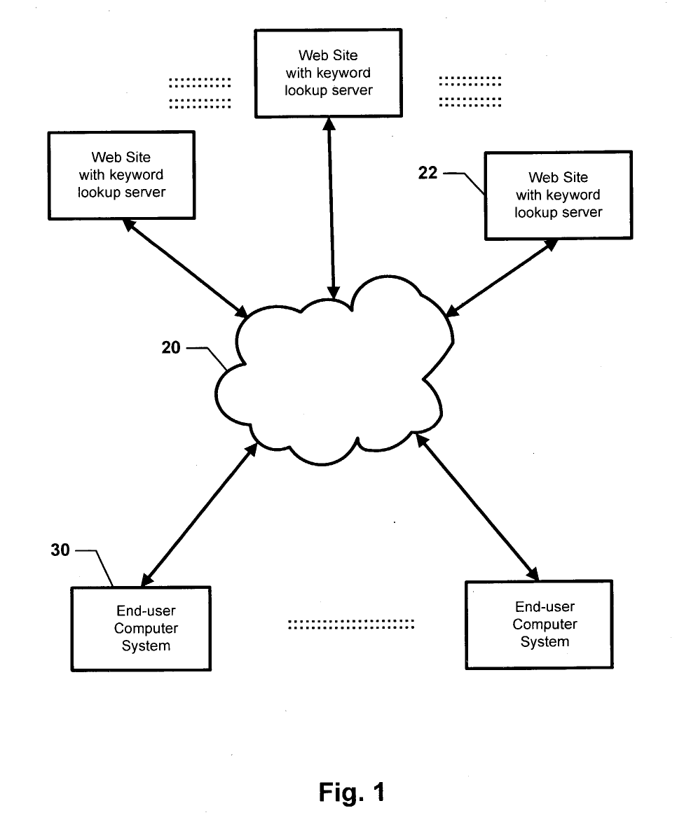

### PREFERRED EMBODIMENT

The present invention provides a method and a system for transparently linking keywords displayed in a document viewer window on a display monitor attached to a computer system to network information and resources, in general, and web objects, in particular. The method for achieving this object is to transparently retrieve a user-selected keyword display in a said document viewer window, invoke a web browser and request the web browser to retrieve information associated with the said keyword on the said web-based information retrieval system (or web site for short). The system comprises of a plurality of end-user computer systems, each executing an access agent of the present invention and a web browser, and one or more web sites, each executing a web server and a keyword lookup server as a server-side CGI process for providing keyword-based information retrieval service. The end-user computer systems (30) and the web sites (22) are coupled to each other over a computer network such as the Internet (20). The document viewer is a document, information or text processing application such as a text editor, a word processor, a web browser, email application, etc. In its simplest configuration, the web site (22) comprises of a web server (21), a keyword lookup server-side process implemented as a server-side CGI program (or functionally equivalent) (23) and hosts a keyword-to-information mapping database (24). The exact structure of the mapping record, the type of information stored and how the lookup server processes the information are application-specific and not in the scope of the present invention. The web server provides front-end HTTP request-response transport service to the application (lookup) server of which service is accessible using standard web access method of Universal Resource Locator, or URL for short. For example, the URL:

http://www.uspto.gov/patent/lookup?kw=“%s”

completely specifies the method for retrieving information associated with a given keyword using standard web access method (HTTP protocol) on a web site of which domain name is “www.uspto.gov”, by accessing a server-side lookup service on the said system at the location “patent/lookup” using a search criteria specified by “kw”. The “%s” is a parameter to be dynamically replaced by a user-selected keyword in query.

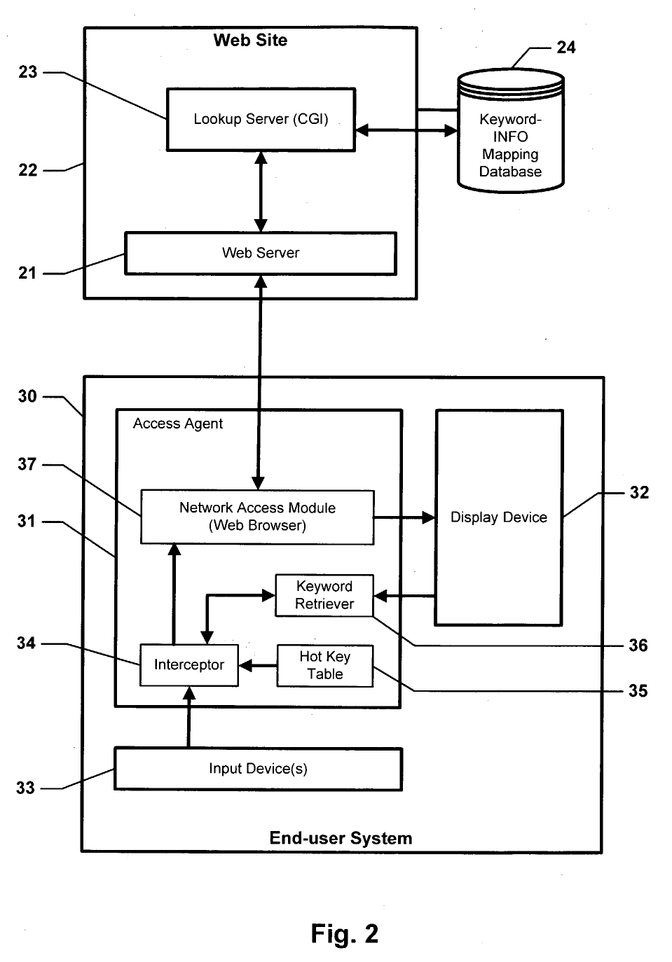

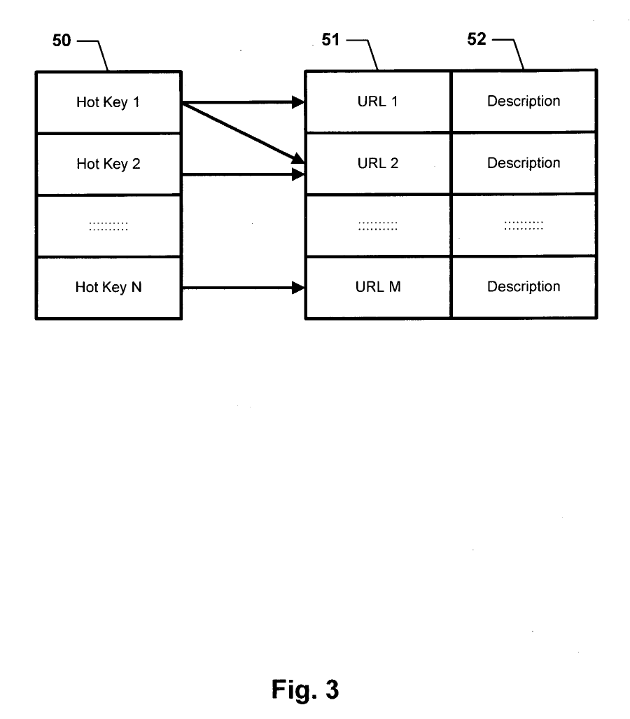

Now, refer to FIG. 2, the end-user's computer system comprising of a processing unit, a display unit (32), at least an input device (33) and optionally a permanent storage. The end-user system further executes an operating system such as Microsoft Windows, Apple Macintosh, etc. The access agent (31) executing in the background on the said end-user computer system comprises of an input device interceptor module (34), keyword retrieval module (36) and a network access module (37). Additionally, the access agent also maintains a hot key table (35) storing one or more user-defined hot key mapping entries. Refer to FIG. 3, the hot key table contains one or more hot key entries, each specifies a hot key (50), one or more associated query URLs (51) and a short description used for generating user-friendly hypertext (52) in the event the URL being listed in a web page. The query URL has a special marker identifying the location where the user-selected keyword will be inserted to complete the query. A sample query URL is as given below:

http://www.website.com/lookup?kw=“%s”

where ‘%s’ is the said special marker and will be replaced by the user-selected keyword. The hot key table can be pre-configured by the user using a configuration dialog and saved in a configuration file on the permanent storage of the end-user computer system or dynamically retrieved from a remote central service center where a user's profile containing such configuration data is maintained. Nevertheless, the said hot key table must be loaded into the access agent's address space prior to the installation of the interceptor module. The interceptor module is responsible for intercepting input events from input devices to identify a hot key event signaling the user's desire for retrieving information associated with a keyword in the document viewer that the user has selected by means of highlighting or positioning an input device's cursor at. The keyword retriever module is responsible for retrieving the user-selected keyword in a document viewer and formatting the retrieved keyword into a format expected by the corresponding lookup server. Such formatting includes stripping off unnecessary characters such as leading and trailing non-printable characters such as blanks, tabs, document control, if any, etc. Normally, the system retrieves a user-selected text (or keyword) in the display buffer associated with the said document viewer window based on certain display attribute convention, e.g. highlighting (or reverse video). Using such conventional display attribute, the system can easily identify the boundary of a user-selected text (or keyword) for retrieval. Another method for identifying a desired word in a document viewer window is by positioning the cursor at the word. In the absence of highlighted text in a display buffer, most, if not all, system often retrieves the word at the current cursor position by default. Still another method for identifying a user-selected keyword in the text displayed in a document viewer is to position the cursor at a keyword displayed in distinct display attribute, e.g. underlined, provided such distinct display attribute is purposely used to identify user-selectable keywords, e.g. hypertexts in web pages. In this case, the keyword retriever module can identify a keyword by retrieving text sharing the same distinct display attribute at the vicinity of the cursor's position. The distinct display distribute can be either statically pre-configured by the user or hard-coded with a conventional distinct display attribute or, alternately, dynamically retrieved from the character at the cursor's position. Nevertheless, the keyword retriever module uses a system-provided API to retrieve a user-selected keyword using one or a combination of the methods explained above. The network access module, when invoked, is responsible for automatically establishing a connection to the network, communicating with the said web site using standard web access method, submitting the user-selected keyword to the said lookup server for retrieving information associated with the said keyword. It also handles receiving and handling of the response from the said lookup server. In this sense, a commercial web browser such as Microsoft Internet Explorer is a good example of such a network access module and, thus, will be used for illustrating how the present invention works. Although the end-user system in discussion is limited to personal computers running a desktop operating system such as Windows, Macintosh, etc. Those skilled in the art readily recognized that the same method can also be used on other network-enabled end-user's computing devices such as a notebook computer, a network computer, a hand-held computer, etc.

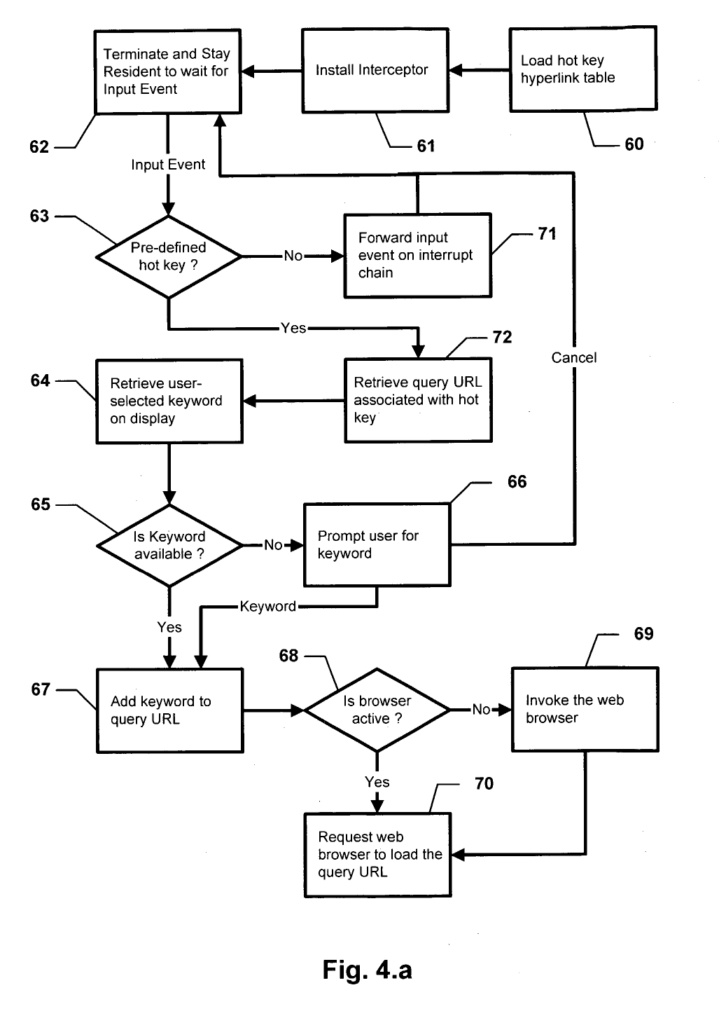

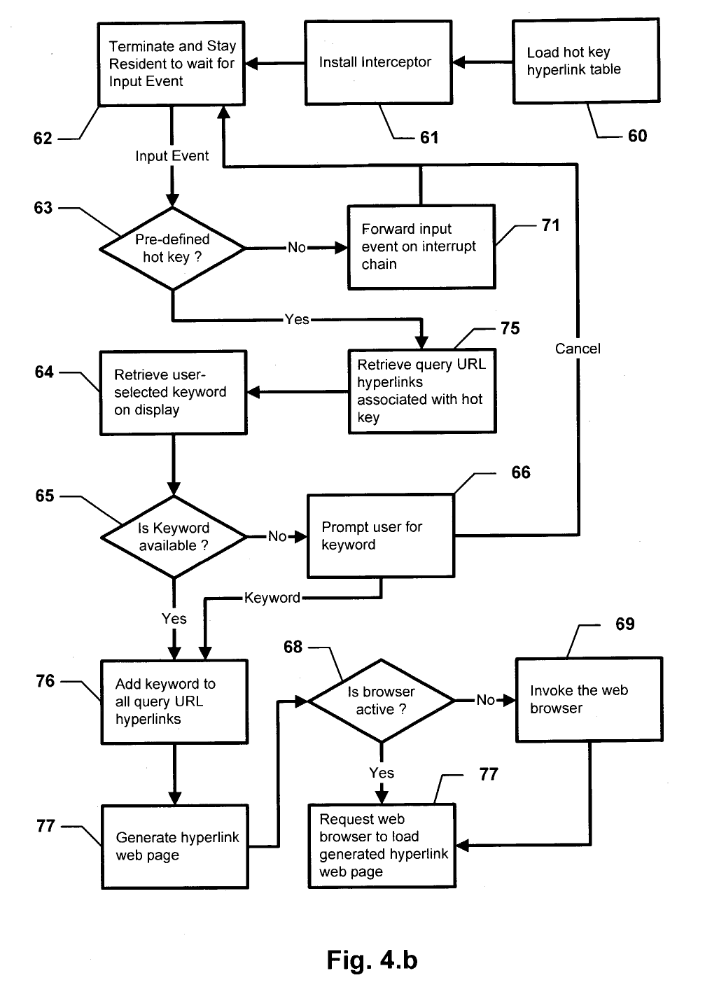

Now, let's refer to FIG. 4.a, when the access agent starts, it loads hot key hyperlink table into memory (60) from the configuration file on the end-user system's permanent storage or from a user's profile stored on a remote central system as described in a previous paragraph. Once the hot key hyperlink table is successfully loaded, the access agent activates its service by installing a hot key interceptor (61) for intercepting input events from all the input devices from which at least a hot key is expected to generate. After the access agent successfully completes the interceptor installation process, the access agent terminates its execution and stays resident in memory waiting to be invoked by a pre-defined hot key event (62). When the user wishes to retrieve information related to a keyword currently displayed in a document viewer, e.g. a word processor, the user selects the said keyword by highlighting it and then applies a desired hot key. Upon receiving an input event resulted from the user's application of the hot key, the interceptor is activated by the system and examines the input event (or data) (63) against the hot key table. If the input event matches one of the pre-defined hot keys in the hot key table, the interceptor retrieves the query URL associated with the hot key, assuming the hot key associates with only one URL at this time. Next, the interceptor invokes the keyword retriever module to retrieve the user-selected keyword in the display buffer associated with the document viewer window (64) for use as the search key. If the keyword retriever fails to retrieve a keyword (65), possibly none has yet been selected by the user. The interceptor can either ignore the hot key event or pop up a dialog to prompt the user for a keyword (66). In the former case, the interceptor terminates its operation and waits for the next input event. In the latter case, if the user specifies a keyword in responding to the prompt, the interceptor will use the keyword (67) as the search key. Otherwise, if the user chooses to abort the lookup operation, the interceptor terminates its operation and waits for the input event (62). It is noted that, during the processing of an input event, the interceptor will not process another input event. Thus, subsequent input events will be ignored and forwarded to other applications' input interceptor in the device handler chain.

Once a user-selected keyword is readily available as the search key, the access agent scans the user-selected keyword for removing unnecessary characters such as leading and trailing non-printable characters, spaces and tabs. It then scans the query URL associated with the user-specified hot key for the ‘%s’ label and then replaces that keyword with the user-selected keyword (67). For example, if the said query URL is:

http://www.uspto.gov/patent/lookup?kw=“%s”

and the lookup keyword is “hot key”, then the resulting query URL used for retrieving information is:

http://www.uspto.gov/patent/lookup?kw=“hot key”

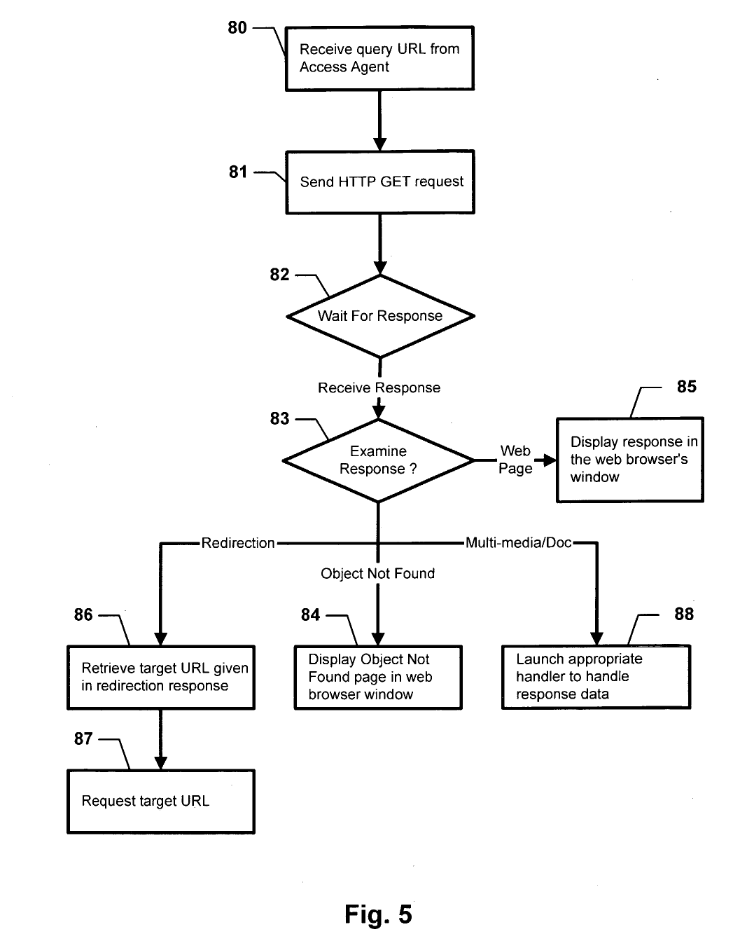

It is noted that the query URL syntax as given above serves only as an example since lookup server on different web sites may implement different argument syntax as well as use different parameter labels. Now, assuming the said network access module is a standard web browser, the access agent then checks the system to see whether an instance of the said web browser is already active (68). If the said web browser is not yet active, the access agent must first start the web browser (69). Next, the access agent simply passes the query URL to the web browser to initiate an information retrieval session with the said lookup server (70). It is noted that the method for invoking or requesting the web browser to access a URL is system- and browser-specific and is not in the scope of the present invention. For example, Internet Explorer 4.0 web browser in Windows 98 operating system can be invoked as a command with the associated URL as an argument in the command line. However, when the said Internet Explorer is already active, an external process can request the web browser to access a URL by simulating a user input of the query URL to the URL specification textbox of the web browser followed by the key code of the Enter key. Now, refer to FIG. 5, as a result of receiving the query URL through a user input simulation process (or equivalent method) (80), the web browser retrieves the web server's address information from the query URL. It then uses the web server's address information to connect to the web server and, if successful, issues an HTTP GET request to the web server on the destined web site for retrieving the information associated with the said keyword (81) as given in the following example:

GET http://www.uspto.gov/patent/lookup?kw=“hot key”

After sending the HTTP GET request to the web server identified by the query URL, the web browser waits for response from the said web server (82). When the web browser finally receives the response for the information retrieval request, it examines the response (83) and handles it using standard receive data handling procedure. For example, if the response is a “Object Not Found” response code, a web page conveying “Object Not Found” message is automatically generated by the web browser and displayed in the web browser window (84). If the response is the URL hyperlink listing web page, the lookup result will be displayed in the web browser window (85) for user's selection. If the response is a redirection response code (86), the web browser will attempt to retrieve the target web object using the URL given in the redirection response message (87). If the response is a data of which type must be handled using a third-party application, it will launch an appropriate application to handle the response data (88), e.g. multimedia data, PDF document, etc. The above scenarios are given as examples to demonstrate how the present invention works. The web browser could also receive other type of response codes. However, they will not be further expanded here.

The process described above applies when the hot key was mapped to a single query URL. For hot key mapped to multiple query URLs, refer to FIG. 4.b, the interceptor will replace the special marker in every associated query URL with the user-selected keyword as previously described (75). It then generates a web page listing the description of each of the query URL as hypertext of which hyperlink is the query URL itself (76). For example, if the user-selected keyword is “hot key” and the query URLs are:

| Query URL | Description |
|---|---|
| http://www.uspto.com/lookup?kw=“%s” | USPTO Database</a> |
| http://patent.ibm.com/lookup?kw=“%s” | IBM Patent Database</a> |
| http://www.jppto.com/lookup?kw=“%s” | JPPTO Database</a> |

Then, the generated web page will contain the following HTML codes:

<a href=http://www.uspto.com/lookup?kw=“hot key”
>USPTO Database</a>
<a href=http://patent.ibm.com/lookup?kw=“hot key”
>IBM Patent Database</a>
<a href=http://www.jppto.com/lookup?kw=“hot key”
>JPPTO Database</a>

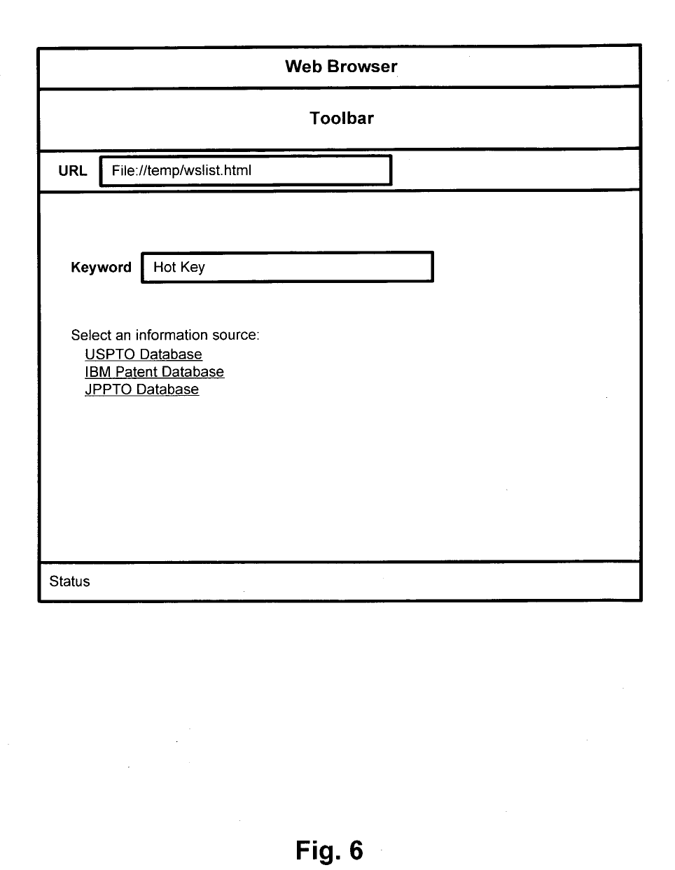

After the said web page is generated, the access agent invokes the web browser to load this generated web page from the local file system in the web browser window (77). Consequently, the hypertexts are displayed in the web browser window for user's further selection as shown in FIG. 6. By simply clicking on the hypertext representing the query URL (or web site), the user can easily browse through various web sites for the desire information associated with the user-selected keyword.

### Other Embodiments

### Keyword-Based Hyperlink

Before exploring the keyword hyperlink method of the present invention, it is useful to revisit the prior art URL hyperlink method that is already in widespread use and supported in many commercial web browsers. In prior art, hypertext is distinctly displayed as user-selectable items in a web browser window with a hidden URL hyperlink that will be used to load a target web object when the user selects the hypertext. For example, Microsoft Internet Explorer presents hypertext in blue and underline display attribute. When the user positions the mouse's cursor at a hypertext and single-clicks on the mouse's left-button, the web browser retrieves the target web object referenced by a URL hyperlink embedded next to hypertext. An example of prior art hypertext in HTML coding is as follow:

<a href=“http://www.abc.com/sample.html”>This is a hypertext</a>

where “This is a hypertext” is the hypertext and “http://www.abc.com/sample.html” is the URL hyperlink linking the text to the web page “sample.html” on “www.abc.com” web site. By convention, a hyperlink is identified by the keyword “href”. When the web browser reads and executes the above HTML code, the hypertext is distinctly displayed in the web browser window as user-selectable item as follow:

This is a Hypertext

In this example, the hypertext is underlined by the web browser to indicate to the user that it is a user-selectable item on the display. When the user applies a single-click (on the left button of the mouse) on the underlined hypertext, the web browser automatically retrieves the web page specified by the URL hyperlink, “sample.html”, and loads the retrieved page in its window. Similarly, hypertext can also be used to link an image displayed in a web page to a target web object, e.g. advertisement image, in the same way as described in HTML coding as follow:

<a href=“http://www.abc.com/index.html”><img src=“images/home.gif”></a>

When the user clicks on the image, “home.gif”, the target web page, “index.html”, is retrieved and loaded in the web browser window.

In this embodiment, the present invention suggests the use of a keyword, instead of a URL, as the hyperlink for linking a hypertext to a target web object as given in the below example:

<a kw=“hypertext”>This is a hypertext</a>

where “hypertext” is a keyword associated with the URL hyperlink, “http://www.abc.com/sample.html”, stored in a keyword-to-URL mapping database on the web site where the original web page is loaded from, or home web site for short. Similarly, an equivalent HTML coding to the above prior art hypertext of an image is:

<a kw=“home”><img src=“images/home.gif”></a>

Where “home” is a keyword associated with the URL hyperlink, “http://www.abc.com/index.html”, stored in the said keyword-to-URL mapping database.

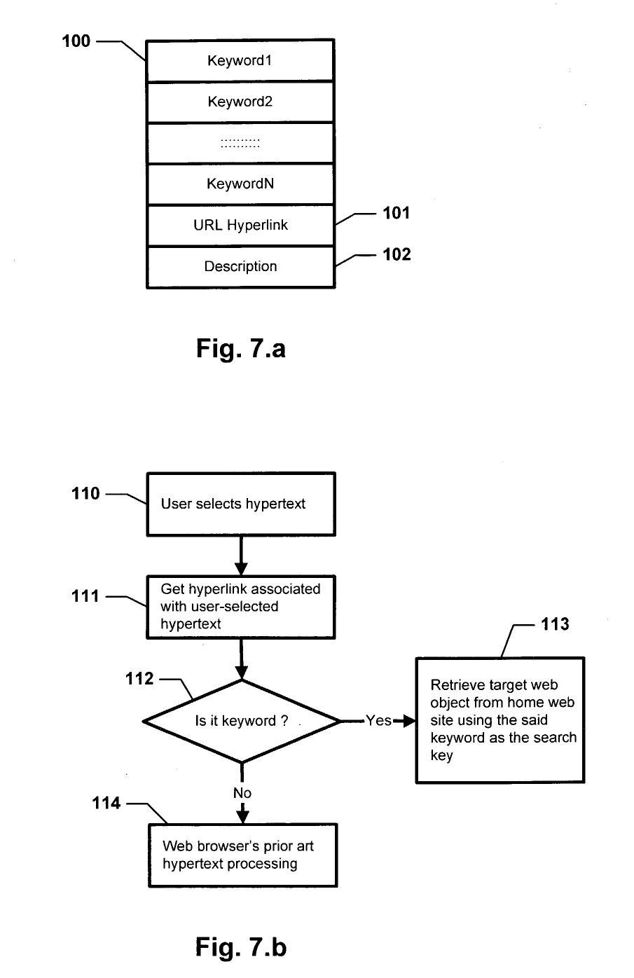

Thus, in this embodiment, the present invention provides a method and a system for keyword hyperlink of web objects in a computer network such as the Internet. The method is to use a keyword, instead of a URL, as the hyperlink. Through a keyword resolution service provided by a keyword lookup server executing on the home web site, the said keyword hyperlink can be resolved into a URL hyperlink identifying the target web object(s) using a keyword-to-URL mapping database. It is noted again that a home web site is a web site from which the web page containing a keyword hyperlink is loaded and, by specification, a URL hyperlink may be an absolute URL specifying a remote web object or a relative URL specifying a local web object. Examples of an absolute URL is “http://www.uspto.com/index.html” and a relative URL is “./index.html” or “index.html” where the pathname of the web object is relative to a directory on the local file system, e.g. a web site's home directory. When a target web object is a local web object, it must be accessible by the keyword lookup server. The system of present invention is similar to previous embodiment. However, each of the said web sites now additionally executes a keyword lookup server operating on a keyword-to-URL mapping database hosted on the said web site. FIG. 7.a illustrates the structure of the keyword-to-URL mapping record in which one or more keywords (100) are associated with a URL (101) identifying the location of a target web object on the local web site or a remote web site. The “Description” field (102) is a short description of the URL used to generate hypertext for display when necessary. Each keyword is stored in an index-able field that can be used as the search key. The maximum number of keyword fields in the record varies depending on specific web site's configuration and is determined when the database is built. Beside, the database record may also contain other fields for management purpose. The said keyword lookup server searches the keyword-to-URL mapping database to retrieve one or more URLs associated with a given keyword. More details on how the keyword lookup server operates will be described later in this embodiment. Each of the said end-user computer systems, however, no longer requires the access agent but executes an enhanced web browser capable of recognizing keyword hyperlinks in incoming web pages, properly storing them in the same way the web browser stores the URL hyperlinks in internal memory for later retrieval. It is noted that exactly how the web browser stores a hyperlink in association with the hypertext varies depending on specific web browser implementation. However, one of the possible methods is that the web browser stores the text part of the hypertext in association with the keyword hyperlink in a hypertext-keyword mapping table.

When a user selects a hypertext of which hyperlink is a keyword, the web browser retrieves the text in display of the hypertext and uses the retrieved text to retrieve the associated keyword hyperlink from the hypertext-keyword mapping table.

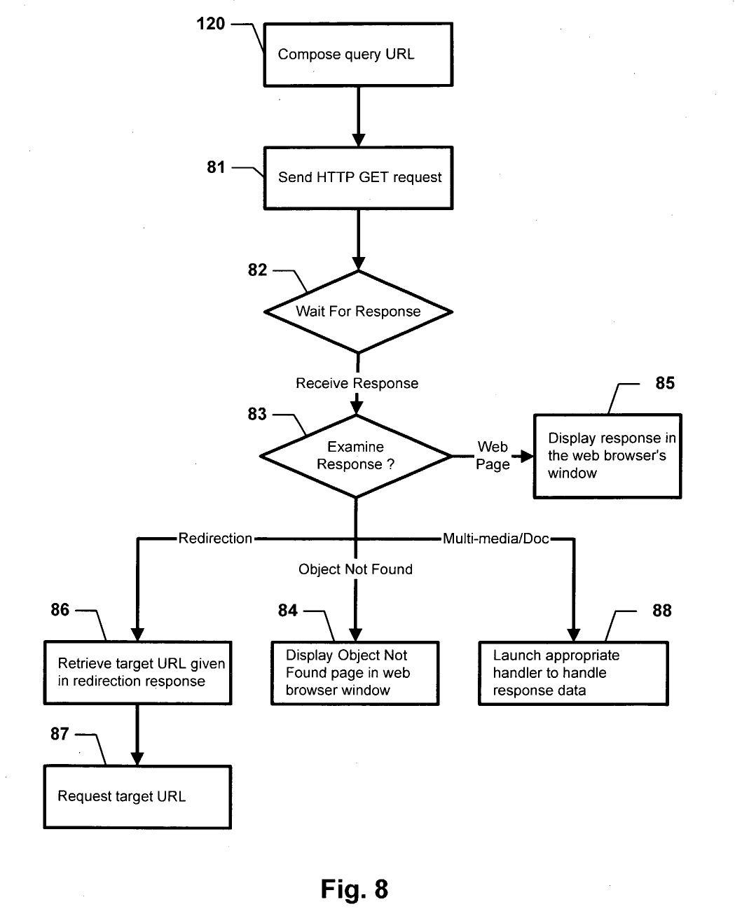

Refer to FIG. 7.b, when the user selects a hypertext displayed in the web browser window (110) by positioning the mouse's cursor on the hypertext and clicking the mouse's left button, the web browser is activated to retrieve the keyword hyperlink associated with the selected hypertext (111) using the method as described in the previous paragraph. The web browser then examines whether the hyperlink is a keyword (112). If it is a keyword, the web browser executes the keyword hyperlink procedure to retrieve the target web object identified by the keyword in the keyword-to-URL mapping database stored on the home web site (113). The home web site is the web site where a web page containing the keyword is loaded from. If the hyperlink is not a keyword, the web browser executes its hyperlink processing procedure as done in prior art (114). Refer to FIG. 8, which describes the web browser's keyword hyperlink procedure. It is noted that this procedure is, again, similar that of already described in the preferred embodiment. The only difference is now the web browser has to compose a query URL on its own (120) instead of receiving it from the access agent that no longer exists in this embodiment. The web browser composes a query URL for keyword resolution by taking the home URL of the said web site, e.g. “http://www.uspto.com”, and appending a conventional pathname of the keyword lookup server on the said web site, e.g. “/lookup”, followed by the said keyword hyperlink in a conventional syntax understood by the said keyword lookup server, e.g. “?kw=keyword”. For example, if the hypertext's HTML code is:

<a kw=“hot key”>This is a hot key</a>

The web browser will generate the following query URL:

http://www.uspto.com/lookup?kw=“hot key”

The web browser then proceeds with issuing an HTTP GET request (81) to the web server on the home web site for resolving the keyword into an associated target web object and then waits for response from the web server (82).

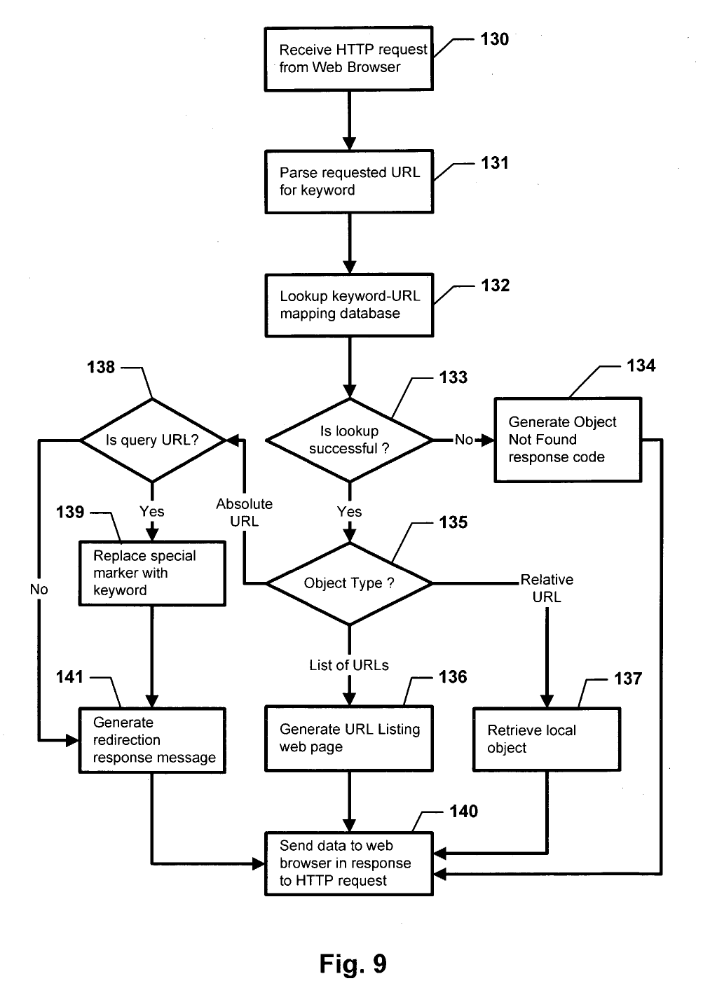

Next, refer to FIG. 9, when the web server of the home web site receives the HTTP GET message from the web browser with the URL identifying the lookup server (130), the web server invokes the lookup server as a CGI process, if it has not yet already been running, and communicates the entire query URL to the lookup server. The lookup server parses the query to retrieve the user-selected keyword in the query URL (131) and uses it as a search key for retrieving matching keyword mapping entries from the said keyword-to-URL mapping database (132). It is noted that the exact method for passing the argument list of a query to the lookup server varies from one web server implementation to another, as well as from one server-side implementation to another, the description here is only for purpose of demonstrating how things may work. If the lookup result is negative, the lookup server generates a “Object Not Found” HTTP response code (134) and sends the response to the requesting web browser (140). If the lookup is successful and the URL hyperlink of the matching entry is an absolute URL referencing a remote web object, the lookup server further examines whether the URL represents a query URL of the present invention (138). If it is such a query URL, the lookup server replaces a special marker in the query URL with the keyword hyperlink in query (139) and then generates a redirection HTTP reply message with the said URL (141) and sends the redirection message to the web browser (140). This redirection message will later cause the requesting web browser to further retrieve the target web object by resolving the keyword hyperlink at the web site identified in the said query URL. If the absolute URL is not in the format of a query URL of the present invention, the lookup server generates a redirection HTTP reply message with the URL of the matching entry included (141) and sends the redirection message to the web browser (140). This redirection message will later cause the requesting web browser to further retrieve the target web object at the location referenced by the URL included in the message. If the lookup result is a pathname (relative URL) referencing a local web object, the lookup server uses the pathname to retrieve the web object on the local storage (137) and sends the resulting web object's data back to the requesting web browser (140). If the lookup result contains several URLs, the lookup server generates a web page listing the matching URLs using either their description, if any, or the URL itself as hypertext (136) and sends the generated web page to the web browser for further user's selection (140). For example, let's assume a keyword “Patent” is mapped to the following URLs:

| URL | Description |
|---|---|
| http://www.uspto.com/ | U.S. Patent Office |
| http://patent.ibm.com/ | IBM Patent Database home |
| | page |
| http://www.jppto.com/ | Japan Patent Office home page |
| http://www.patentlawyers.com/ | |

The generated web page will contain the following lines of HTML codes:

<a href=http://www.uspto.com/ >US Patent Office </a>
<a href=http://patent.ibm.com/ >IBM Patent Database</a>
<a href=http://www.jppto.com/ >Japan Patent Office</a>
<a href=http://www.patentlawyers.com/
>http://www.patentlawyers.com</a>

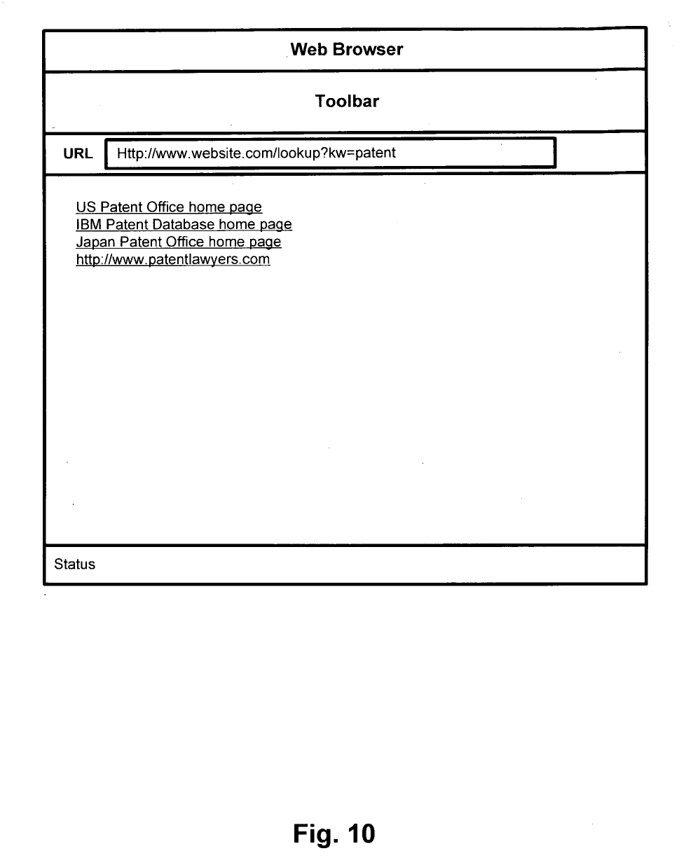

which will later be displayed as hypertexts in the web browser window as shown in FIG. 10.

Now, let's go back to FIG. 8, when the web browser finally receives a response for the keyword resolution request and handles it as described in the previous embodiment.

It is noted that the present invention of keyword hyperlink does not attempt to replace the prior art hyperlink. It is only intended as an improvement over prior art for minimizing the occurrence of location-based hyperlinks, i.e. URLs, in web pages and, thus, the associated “lost-link” problem. As such, the operation of the enhanced web browser of the present invention is fully compatible with prior art web browsing technology.

### Keyword Hyperlink—HTML Extension for Resolution URL

In the previous embodiment, it has been assumed that the lookup server is named as “lookup” and always resides at a pre-determined directory of a web site by convention so that the web browser can compose a keyword hyperlink resolution URL by using the above assumptions. To allow for more flexibility, the web page can also carry a keyword hyperlink resolution URL specifically for resolving keyword hyperlinks occurred in the said web page in a private HTML tag comprising of a starting tag and an ending tag, e.g. <kwr> and </kwr>, respectively, with the URL enclosed. For example:

<kwr>http://www.website.com/anypathname/lookup?kw=%s</kwr>

where “anypathname” is a pathname from the web site's home directory to the directory where the lookup server resides. “lookup” is the file name of the lookup server which can be any other valid filename on the operating system in use. ‘%s” is a special marker to be replaced by the keyword hyperlink.

In this case, the web browser must parse incoming web page for such HTML tag and pick up the keyword resolution URL, if any. When the web browser later needs to perform a keyword hyperlink resolution, the web browser will use this URL with the special marker replaced by the keyword instead of dynamically composing one a described above. However, in the absence of the keyword hyperlink resolution URL embedded in a web page, the composing method as described in previous embodiment could still be used as the last resort.

Keyword Hyperlink—Central Database

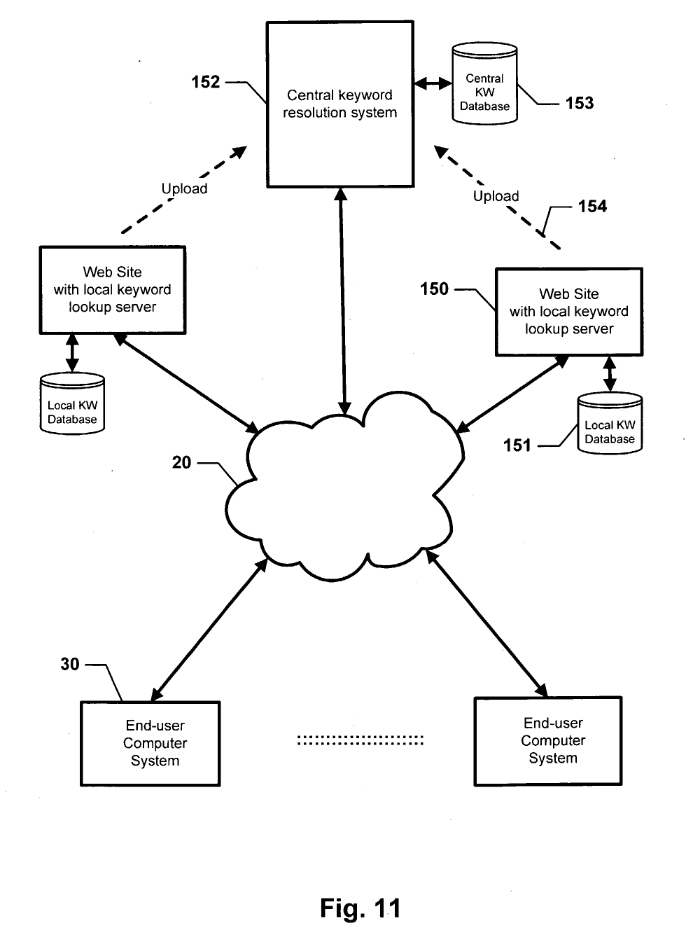

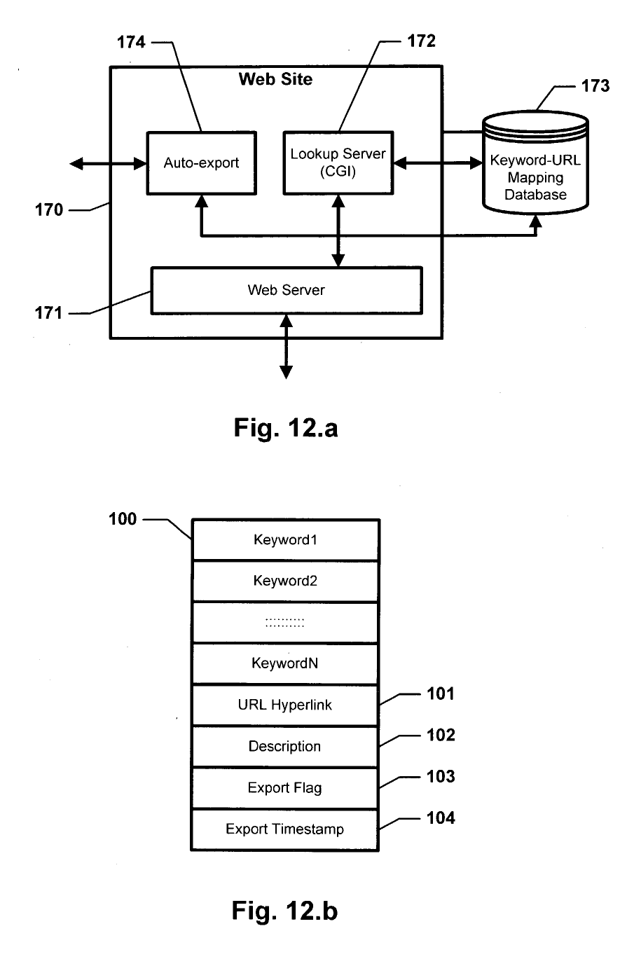

In this embodiment, selected keyword mapping entries in a keyword-to-URL mapping database on a web site will be exported, or advertised or uploaded, to a keyword-to-URL mapping database on a central keyword resolution system. Furthermore, the web site will redirect a requesting web browser to the central keyword resolution system for further resolution of a keyword hyperlink in the event the web site fails to resolve the said keyword hyperlink locally. Exported keyword mapping entries are those a web site owner wishes to be accessible globally. Examples of such keywords are company name, product names, service names, etc., while non-export keywords are those having local meaning such as “home”, “product”, “service”, “contact us”, etc. The purpose of the central keyword database is to help avoid duplication of well-known or unique keywords on web sites referencing them and, thus, associated maintenance and synchronization burdens. Refer to FIG. 11, which shows a central keyword resolution system (152) hosting a said central keyword-to-URL mapping database (153) and a plurality of web sites (150), each maintaining its own keyword-to-URL mapping database (151). Also in this figure, the dashed arrow (154) indicates the direction of the export process. Now, refer to FIG. 12.a, which shows a close-up view of a typical web site of this embodiment, which hosts a keyword-to-URL mapping database (151) and executes a web server (171), a lookup server (172) and an upload client module (173). Refer to FIG. 12.b, the keyword-to-URL mapping record structure now includes Export flag (103) to indicate whether it is exportable and an Export timestamp. The Export flag is set to GLOBAL or LOCAL when a new keyword entry is added to the database and is used by the upload client module only. The Export timestamp is initially set to 0 and when the record is successfully uploaded, it is reset to the upload time. Thus, a non-zero Export timestamp also indicates that the mapping entry has already been uploaded to the central keyword-to-URL mapping database.

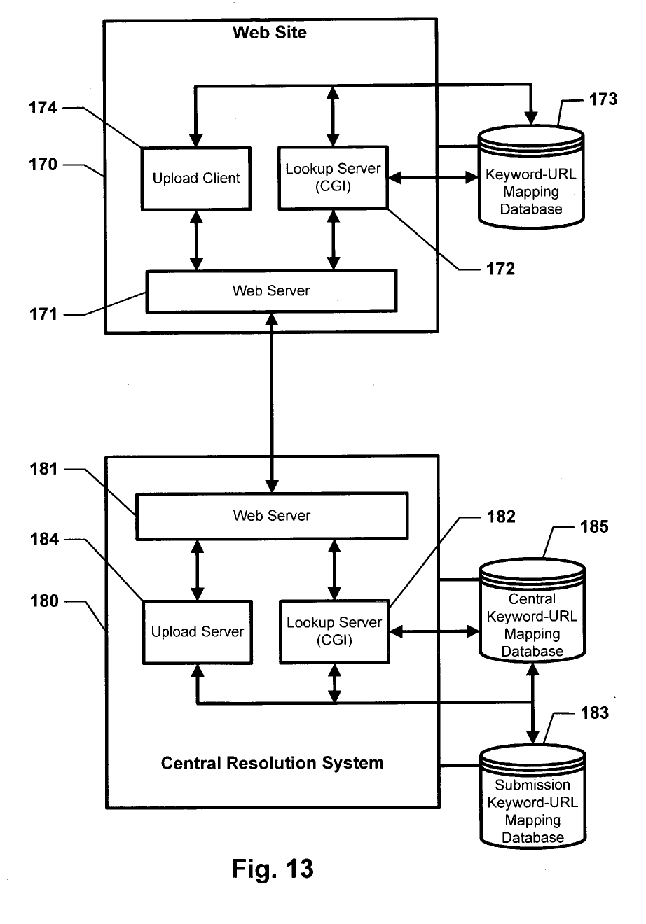

Refer to FIG. 13, which illustrates a web site of this embodiment (170) and a central database system (180) along with their own executing components. The keyword upload process of this embodiment is initiated by the upload client process (174) executing on every web site of this embodiment. The upload client module is invoked by a timer on periodic basis, although it can be also be invoked on-demand through an expedite command initiated from an administration console by the web site administrator. When invoked, the upload client module queries the local keyword-to-URL mapping database (173) to look for keyword-to-URL entries with the Export flag set to GLOBAL. If there is at least an entry as a result of the lookup, the upload client module will establish an upload session with an upload server (184) on the central keyword resolution system (180). The upload session can be carried out over a reliable TCP connection using either a client-server communication model through a private service port or even the standard web access method (HTTP) through a standard web service port (port 80). In the later case, the upload server can be implemented as a server-side CGI process similar to the keyword lookup server and the upload client must use HTTP messages for communicating with the said upload server. When the upload session is fully established, the upload client can start sending the keyword mapping entries to the upload server. Upon receiving the keyword mapping entries from the upload client, the upload server imports them to a submission database. Assuming the upload process is successful, the Export timestamp of every uploaded entries will be set to current timestamp to indicate that the said entry has been uploaded to the central keyword-to-URL mapping database so that it will not be qualified for upload again in the next upload run. The uploaded keyword-to-URL entries will remain in the submission database until a central database system administrator reviews and approves the submitted mapping entries. The approved keyword-to-URL records will be automatically published to the central keyword-to-URL database (183) where they can be used by the keyword lookup server on the central resolution system for resolving keyword hyperlink resolution requests.

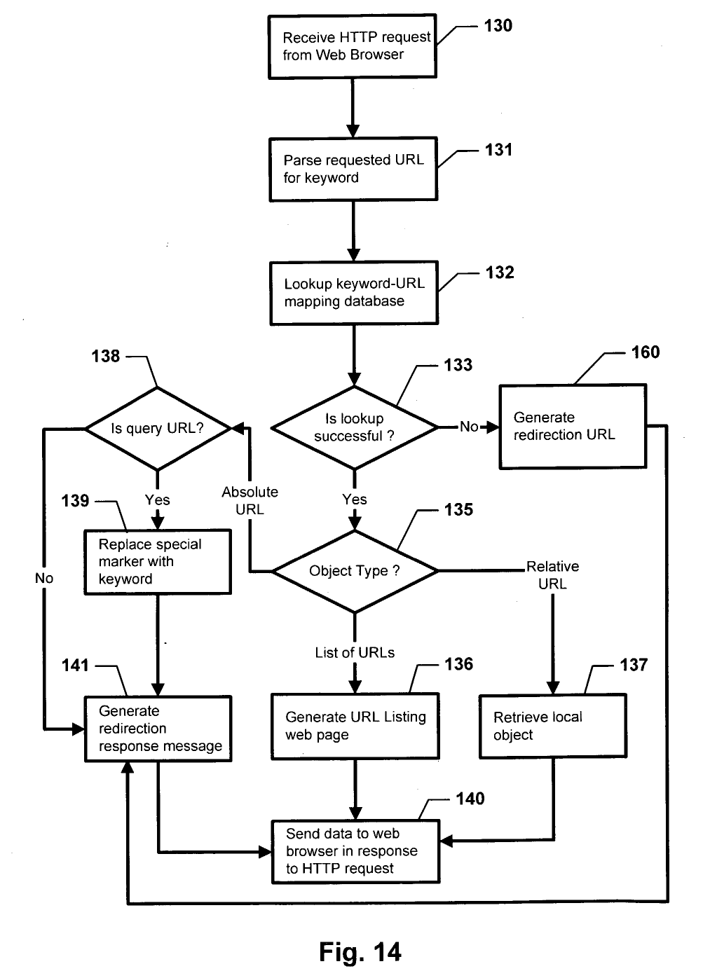

It is noted that the URL used for querying the central database system is pre-configured on every web site of this embodiment so that the web site can redirect failed local lookups to the central database system. Again, this URL also has a special marker that will be dynamically replaced by the keyword hyperlink in resolution. Now, refer to FIG. 14, which shows a flowchart describing the lookup server on the web site in this embodiment. It is noted that the flowchart in this figure is modified from FIG. 9 to demonstrate the additional processing required in this embodiment. As shown in the flowchart, the lookup server on a web site, after trying to resolve the keyword on the keyword-to-URL mapping database without success, will redirect the web browser to resolve the keyword on the central web site. To do this, the lookup server composes a URL for resolving the keyword hyperlink on the central resolution system by replacing the special marker in the pre-configured URL with the keyword hyperlink in resolution (160) and including this composed URL in the redirection response message (138). It then sends the redirection message to the requesting web browser in responding to its keyword resolution request (140). When the web browser receives the redirection message, it will retrieve the URL included in the redirection response and uses it to further resolve the keyword hyperlink on the central resolution system. It should be noted that the keyword resolution process of the lookup server on the central database system is the same as previously described in FIG. 9.

### Keyword Hyperlink—Web Site Registration

In another embodiment, web sites must register with the central keyword resolution system in order to receive the upload privilege. Registered web sites will be provided with a logon and password and their registration profile are stored in a registration database. When establishing an upload session with the upload server, the upload client must provide the given logon and password information in the upload request message so that the upload server can authenticate the requester before granting access to its upload service. The upload server authenticates the requester by using the logon provided in the upload request message to look up the registration database, if no record is found, the upload server will reject the request by responding with a negative acknowledgement and then closing the upload session. Otherwise, the upload server continues the authentication process by retrieving the password from the upload request and compares it with the password stored in the matching registration record. If they do not compare, the upload server rejects the request, again, by responding with a negative acknowledgement and then closing the upload session. Otherwise, the upload server responds with a positive acknowledgement and allows the upload request to proceed as described in the previous embodiment.

### Conclusions, Ramifications, and Scope

Accordingly, it can be seen that the present invention of a method for linking keyword to information employing an access agent executing on the end-user computer system has instantly and transparently hyperlinked any keywords in any document viewers to associated information on a computer network. In prior art, hypertext, i.e. hyperlinked text, must be prepared by the editor through a time-consuming editing process, not to mention the cost of update maintenance when the location of hyperlinked target web objects change. For this reason, hyperlink is only in limited use among the technical novice editors. With the present invention, any keywords in any document viewer are instantly hyperlinked to popular web-based information sources without the cost of preparation and maintenance. When enhancing the prior art web browser to take advantage of the present invention, hypertext can also be hyperlinked to web objects by means of user-friendly keywords instead of lengthy and cryptic location-based URL. Not only the present invention helps web pages to be more readable by web programmers but it also reduces the web browsing technology's dependency on hard-to-manage location-dependent URL and, thus, minimizes the associated well-known “lost-link” problem that has caused a lot of frustrations among Internet users.

Although the description above contains many specific details, these should not be construed as limiting the scope of the invention but as merely providing illustrations of some of the presently preferred embodiments of this invention. Various other embodiments and ramifications are possible within its scope. For example, the upload session between the said web site and the said central keyword resolution system can be further secured through an additional web site registration process or using a secure connection (SSL). However, they are now standard practices and obvious to those skilled in the art and, thus, needless for describing in this specification.

Thus, the scope of the present invention should be determined by the appended claims and their legal equivalents, rather than by the examples given.

What is claimed is:

1.) A method for transparently linking keywords in a document, displayed in a document viewer on a display monitor attached to an end-user computer system, to information on a web site offering keyword-based information lookup service comprises of the steps:
a) Defining a hot key on an input device attached to the said end-user system and mapping the said hot key to a URL containing a special marker to be replaced by a user-selected keyword and used to query the said lookup service on the said web site for information relating to the said user-selected keyword
b) Selecting a keyword in a document viewer on the said display by either:
i) highlighting the said keyword or
ii) positioning an input device's cursor at or on top of the said keyword or
iii) positioning an input device's cursor at or on top of a keyword displayed in a distinct display attribute
c) Applying the said hot key
d) Intercepting user input from the said input device for detecting the said hot key event
e) Upon detecting the said hot key event from the said input device, further executing the steps:
i) Retrieving the said keyword selected in step b) by either:
(1) Retrieving highlighted text from the display buffer of the said document viewer and trimming off leading and trailing word separation characters or
(2) Retrieving a single word at the cursor position or
(3) Retrieving distinctly-displayed text at the cursor's position from the display buffer of the said document viewer using the said distinct attribute as selected text boundary
ii) If the keyword retrieval in step i) is successful, continuing on next step; otherwise, ending processing
iii) Retrieving the said URL associated with the said hot key and replacing the said special marker in the said URL with the said keyword retrieved in step i)
iv) Invoking a web browser on the said end-user computer system, if an instance of said web browser has not yet been running, for retrieving information associated with the said user-selected keyword and handling the retrieved information in accordance to the standard receive data handling procedure of the said web browser by passing the said URL resulted in step iii) to the said web browser using one of the below methods:
(1) Passing the said URL as an argument of the command to invoke the said web browser or
(2) Simulating an input of the said URL to the URL specification field of the said web browser from a keyboard followed by the key code of the Enter key or
(3) Using an external API provided by the said web browser

2.) A method in claim 1) wherein the user will be prompted for inputting a keyword using a popup dialog if the step e.i) of claim 1) is unsuccessful and, if a keyword is specified by the user through the said popup dialog, continuing on step e.iii) of claim 1).

3.) A method in claim 1) and 2) wherein a plurality of the said hot keys are defined on one or more input devices attached to the said end-user computer system, each mapped to a query URL for querying a said keyword lookup service on a said web site for information relating to a user-selected keyword

4.) A method in claim 3) wherein one or more said hot keys are mapped to a plurality of said query URLs and, upon detecting a said hot key event of this claim from a said input device as described in step e) of claim 1), executing the steps below in place of the steps e.i) to e.iv) of claim 1):
b) Retrieving the said keyword selected in step b) of claim 1) by either:
i) Retrieving highlighted text from the display buffer of the said document viewer and trimming off leading and trailing word separation characters or
ii) Retrieving a single word at the cursor position or
iii) Retrieving distinctly-displayed text at the cursor's position from the display buffer of the said document viewer using the said distinct attribute as selected text boundary
c) If the keyword retrieval in step a) is successful, continuing on next step; otherwise, ending processing
d) Retrieving the said URLs associated with the said hot key and replacing the said special marker in every of the said URLs with the said keyword retrieved in step a)
e) Generating a web page listing every of the said URLs resulted in step b) as hypertext
f) Invoking the said web browser on the said end-user computer system, if an instance of said web browser has not yet been running, and requesting the said web browser to load the said web page generated in step e) in the said web browser window using one of the methods described in steps e.iv.(1)) to e.iv.(3)) of claim 1).

5.) A method for hyperlinking a hypertext in a web page, displayed in a web browser window on a display monitor attached to an end-user computer system, to a web object on a remote web site using a keyword as the hyperlink, wherein the said web site is coupled to the said end-user computer system over a computer network and executes a keyword lookup server operating on a keyword-to-URL mapping database of which entry comprises of one or more keywords, an associated URL and a brief description of the target web object referenced by the said URL, the said keyword lookup server is stored in a designated location under the said web site's home directory by convention, comprising of the steps:
a) Assigning a keyword as a hyperlink to the said hypertext in a web page on the said web site
b) Loading the said web page onto the said web browser window, while loading taking place, parsing the said web page for hypertexts of which hyperlink being a keyword and storing the text part of the said hypertext in association with the said keyword hyperlink in a hypertext-to-keyword mapping table
c) Recording the home URL of the said web site from the URL used to load the said web page
d) Selecting the hypertext in the said web page displayed in the said web browser window
e) Upon receiving the said hypertext selection event and after determining that the hyperlink of the said hypertext being a said keyword hyperlink, the said web browser further executing the steps:
i) Retrieving the text of the selected hypertext in display from the display buffer of the said web browser window using the distinct display attribute of the said hypertext as the text boundary
ii) Retrieving the keyword hyperlink associated with the said retrieved text from the said hypertext-to-keyword mapping table
iii) Composing a query URL for querying the said keyword lookup server on the said web site by using the said recorded home URL, the pathname of keyword lookup server relative to the web site's home directory and the keyword hyperlink
iv) Retrieving a web object associated with the said keyword hyperlink from the said web site by using the said URL composed in step iii), upon receiving the said query URL, the said keyword lookup server further executes the steps:
(1) Retrieving the said keyword hyperlink from the said query URL
(2) Querying the said keyword-to-URL mapping database using the said keyword hyperlink as the search key for an exact match and if the result of the said query is:
(a) A matching mapping entry of which URL referencing a local web object, retrieving the web object and responding to the said web browser with the web object data
(b) A matching mapping entry of which URL referencing a remote web object, responding to the said web browser with a redirection response code along with the resulting URL
(c) A matching mapping entry of which URL in the form of a query URL, with an embedded special marker to be replaced by a keyword hyperlink, referencing a keyword lookup server on a remote web site, replacing the said special marker with the keyword hyperlink in query and responding to the said web browser with a redirection message along with the resulting query URL
(d) Multiple matching mapping entries, generating a web page listing the URL of said entries as hypertext and responding to the said web browser with the generated web page data
(e) negative, responding to the said web browser with a “object not found” response code
v) Handling the retrieved web object in accordance to the standard receive data handling procedure of the said web browser

6.) A method in claim 5) wherein the said web browser further parses the web page on loading for a private HTML tag specifying a URL containing a special marker to be replaced by a keyword hyperlink, and, if a said URL is identified in a loading web page, using the said URL for keyword hyperlink resolution instead of the composed URL as described in step e.iii) of claim 5).

7.) A method in claim 5) and 6) wherein the said web site is pre-configured with a URL, with an embedded special marker to be replaced by a keyword hyperlink, for resolving a keyword hyperlink on a central keyword resolution system coupled to the said end-user computer system and the said web site over a computer network and also executing a said keyword lookup server for providing web-based keyword hyperlink resolution service using a keyword-to-URL mapping database on the said central web site, in the event the keyword hyperlink resolution procedure described in step e.iv.(2)) of claim 5) on the said web site results in no matching mapping entries, instead of responding to the said web browser as described in step e.iv.(2).(e)), the said keyword lookup server on the said web site redirects the said web browser to further resolve the said keyword hyperlink on a central keyword resolution system by:
a) replacing the said special marker in the said pre-configured URL with the said keyword hyperlink and
b) generating a redirection message including the said URL resulted in step a) in responding to the said requesting web browser.

8.) A method in claim 7) wherein the said central keyword resolution system further executes an upload server for receiving upload of keyword-to-URL mapping entries from the said web site and adding the said uploaded mapping entries to the said central keyword-to-URL mapping database on either periodic or demand basis.

9.) A method in claim 8) wherein the said upload server temporarily stores the said uploaded mapping entries in a submission keyword-to-URL mapping database on the said central keyword resolution system for undergoing an approval process applied by an administrator of the said central keyword resolution system prior to being published to the said central keyword-to-URL mapping database.

10.) A method in claim 8) to 9) wherein the administrator of the said web site must register with the said central database system for upload privilege and, during the registration process, the said web site administrator obtains logon data, comprising of a logon and a password, to be included in the upload request message for authentication and, upon receiving a said upload request message from a said registered web site, the upload server further executes the steps:
a) Retrieving the logon data from the upload request
b) Authenticating the said logon data against a web site registration database and
c) Examining the authentication result,
i) If the said authentication is successful, responding to the requesting web site with a positive acknowledgement and allowing the upload process to proceed
ii) If the said authentication fails, responding to the requesting web site with a negative acknowledgement and disconnecting the upload session

11.) A system for transparently linking keywords in a document, displayed in a document viewer on a display monitor attached to an end-user computer system, to information on a web site offering keyword-based information lookup service comprising of an end-user computer system executing an access agent, a web browser and at least a document viewer, and one or more said web sites coupled to the said end-user computer system over a computer network, the said access agent further comprising of:
a) A hot-key-to-URL mapping table containing one or more hot key mapping entries configured using a configuration dialog executing on the said end-user system, stored on the permanent storage of the said end-user system, loaded in memory by the said access agent on startup and automatically reloaded on changes to the said hot key table, each hot key mapping entry storing a hot key in association with one or more URLs, each said URL referencing a lookup service provided by a said web site and containing a special marker to be replaced with the keyword in query
b) An interceptor module installed to the system by the said access agent during initialization for:
i) intercepting input events from one or more input devices whereas the said hot keys are expected,
ii) determining whether an input event or chain of continuous input events constituting a hot key in the said hot key mapping table and, upon detecting a said hot key, executing the steps as described in:
(1) steps e.i) to e.iv) of claim 1), if a said hot key is mapped to a single URL, or
(2) steps a) to e) of claim 4), if a said hot key is mapped a plurality of said URLs.

12.) A system in claim 11) wherein, in the event the user has not selected a keyword as described in step b) of claim 1), the said interceptor further examines a user-selected option, and depending on the said option setting, the said interceptor either ignores or prompts the user for a keyword using a popup dialog.

13.) A system in claim 11) to 12) wherein the said hot key table is configured and maintained on a remote system and, on startup, the said access agent further executing the steps:
a) Downloading the said hot key table from the said remote system and, if the download succeeds, storing the said downloaded hot key table in a configuration file on a permanent storage of the said end-user computer system
b) Loading the said downloaded hot key table from the said configuration file into memory for later use

14.) A system in claim 11) to 13) with a plurality of said end-user computer systems.

15.) A system for keyword-based hyperlink of web documents comprising of an end-user computer system and a web site coupled to the said end-user computer system over a computer network, wherein:
a) the said end-user computer system executes a web browser enhanced to perform additional functionality as described in the steps b), c) and e) of claim 5) and
b) the said remote web site hosts a keyword-to-URL mapping database and executes a web server and a keyword lookup server providing a web-based keyword lookup service for resolving a given keyword into a web object using a keyword-to-URL mapping database and the method as described in step e.iv) of claim 5).

16.) A system in claim 15) with the said web browser enhanced to include the method in claim 6).

17.) A system in claim 15) and 16) with a plurality of said end-user computer systems.

18.) A system in claim 15) to 17) with a plurality of the said remote web sites.

19.) A system in claim 18) with the addition of a central keyword resolution system coupled to the said end-user computer systems and the said web sites over a computer network and executing a said web server, a said keyword lookup server for providing keyword resolution service based on a central keyword-to-URL mapping database on the said central keyword resolution system and an upload server for receiving keyword-to-URL mapping entries uploaded from the said web sites using the method as described in claim 7), wherein:
a) the said keyword lookup server on the said central keyword resolution system operates as described in step e.iv) of claim 5) and
b) the said keyword lookup server on the said web sites is enhanced to redirect a requesting web browser to the said central keyword resolution system for further keyword hyperlink resolution, in the event the said keyword lookup server fails to locally resolve a keyword hyperlink.

20.) A system in claim 19) wherein the keyword-to-URL mapping entries uploaded from the said web sites are managed as described in claim 9).

21.) A system in claim 18) using the method as described in claim 10) for authorizing upload of keyword-to-URL mapping entries to the said central keyword-to-URL mapping database from the said web sites.
